(19) United States
(12) Patent Application Publication
(10) Pub. No.: US 2021/0256498 A1
(43) Pub. Date: Aug. 19, 2021

(54) DIGITAL COMMUNICATIONS AT POINT OF SALE

(71) Applicant: John Eric DeTitta, Fairport, NY (US)

(72) Inventor: John Eric DeTitta, Fairport, NY (US)

(21) Appl. No.: 17/179,118

(22) Filed: Feb. 18, 2021

Related U.S. Application Data
(60) Provisional application No. 62/995,848, filed on Feb. 18, 2020.

(51) Int. Cl. G06Q 20/32

(52) U.S. Cl. CPC G06Q 20/3276; G06Q 20/3278

(57) ABSTRACT

Embodiments of the present invention include a computer program product, a computer-implemented method, and a system, where program code executing on one or more processors (on a client) obtains a signal of decodable indicia from a physical medium at a point-of-sale. The program code decodes the signal of decodable indicia to access decoded data, which automatically launches a web browser and navigates the browser to a unique uniform resource locator. The program code initiates, at the unique uniform resource locator, an electronic transaction selected from the group consisting of: initiating an electronic commerce transaction, accessing content posted at the uniform resource locator, and transmitting an electronic communication.

### CROSS REFERENCE TO RELATED APPLICATIONS

This application claims priority from U.S. provisional patent application number 62/995,848 filed Feb. 18, 2020, entitled, “METHOD AND SYSTEM TO ALLOW DIGITAL TIPPING THROUGH PRODUCT QR PLACEMENT,” which is hereby incorporated herein by reference in its entirety for all purposes.

### BACKGROUND OF INVENTION

Point-of-sale interactions are frequent interactions between customers and service providers, but these frequent interactions are generally purely transaction and do not extend any contact or interactions or business relationships beyond the payment for the services rendered. Given the frequency with which transactions take place, the one-time nature of the interaction is arguably a missed opportunity to form a more lasting or meaningful relationship.

### SUMMARY OF INVENTION

Shortcomings of the prior art are also overcome and additional advantages are provided through the provision of a method for facilitating electronic communications at a point-of-sale. The method includes: obtaining, by one or more processors of a computing device, a signal of decodable indicia, where the signal of decodable indicia is obtained by the computing device from a physical medium at a point-of-sale; decoding, by the one or more processors, the signal of decodable indicia to access decoded data, where based on accessing the decoded data, the one or more processors automatically launch a web browser and navigate, based on the decodable data to a unique uniform resource locator, where the uniform resource locator is specified by the decoded data; and initiating, by the one or more processors, based on input through a graphical user interface by a user of the computing device, at the unique uniform resource locator, an electronic transaction, where the electronic transaction is selected from the group consisting of: initiating an electronic commerce transaction, accessing content posted at the uniform resource locator, and transmitting an electronic communication.

Shortcomings of the prior art are also overcome and additional advantages are provided through the provision of a system for facilitating electronic communications at a point-of-sale. The system includes: a memory; one or more processors in communication with the memory; program instructions executable by the one or more processors via the memory to perform a method, the method comprising: obtaining, by one or more processors of a computing device, a signal of decodable indicia, where the signal of decodable indicia is obtained by the computing device from a physical medium at a point-of-sale; decoding, by the one or more processors, the signal of decodable indicia to access decoded data, where based on accessing the decoded data, the one or more processors automatically launch a web browser and navigate, based on the decodable data to a unique uniform resource locator, where the uniform resource locator is specified by the decoded data; and initiating, by the one or more processors, based on input through a graphical user interface by a user of the computing device, at the unique uniform resource locator, an electronic transaction, where the electronic transaction is selected from the group consisting of: initiating an electronic commerce transaction, accessing content posted at the uniform resource locator, and transmitting an electronic communication.

Shortcomings of the prior art are also overcome and additional advantages are provided through the provision of a computer program product for facilitating electronic communications at a point-of-sale. The computer program product includes a computer readable storage medium readable by one or more processors and storing instructions for execution by the one or more processors for performing a method comprising: obtaining, by one or more processors of a computing device, a signal of decodable indicia, where the signal of decodable indicia is obtained by the computing device from a physical medium at a point-of-sale; decoding, by the one or more processors, the signal of decodable indicia to access decoded data, where based on accessing the decoded data, the one or more processors automatically launch a web browser and navigate, based on the decodable data to a unique uniform resource locator, where the uniform resource locator is specified by the decoded data; and initiating, by the one or more processors, based on input through a graphical user interface by a user of the computing device, at the unique uniform resource locator, an electronic transaction, where the electronic transaction is selected from the group consisting of: initiating an electronic commerce transaction, accessing content posted at the uniform resource locator, and transmitting an electronic communication.

Systems, computer program products, and computer-implemented methods relating to one or more aspects of the technique are also described and may be claimed herein. Further, services relating to one or more aspects of the technique are also described and may be claimed herein.

Additional features are realized through the techniques of the present invention. Other embodiments and aspects of the invention are described in detail herein and are considered a part of the claimed invention.

### BRIEF DESCRIPTION OF DRAWINGS

One or more aspects of the present invention are particularly pointed out and distinctly claimed as examples in the claims at the conclusion of the specification. The foregoing and objects, features, and advantages of one or more aspects of the invention are apparent from the following detailed description taken in conjunction with the accompanying drawing.

FIG. 1 depicts a technical environment into which aspects of some embodiments of the present invention have been implemented.

FIG. 2 is a workflow that illustrates various aspects of some embodiments of the present invention.

FIG. 3 is a workflow that illustrates various aspects of some embodiments of the present invention.

FIG. 4 depicts a computer system configured to perform an aspect of an embodiment of the present invention.

FIG. 5 depicts a computer program product incorporating one or more aspects of the present invention.

FIG. 6 is an example of a screenshot of a secure website which a service provider can utilize to establish a profile and which a customer can access to continue interactions with the service provider, including but not limited to tipping the service provider.

FIG. 7 is an example of a screenshot of an ecommerce store which a service provider can utilize to purchase items that include a signal of decodable indicia.

FIG. 8 is an example of a sign up page which a user can utilize to establish a URL (e.g., a webpage on the secure website) which decoding a signal of decodable indicia will direct a customer to.

FIG. 9 is a sample workflow from the point of view of a service provider.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. The terms software and program code are used interchangeably throughout this application and can refer to logic executed by both hardware and software. Components of the system that can be utilized to execute aspects of embodiments of the present invention may include specialized hardware, including but not limited to, a GPP, an FPGA and a GPU (graphics professor unit). Additionally, items denoted as processors may include hardware and/or software processors or other processing means, including but not limited to a software defined radio and/or custom hardware.

Embodiments of the present invention include methods, systems, and computer program products that provide for digitally extending what are, generally, brief interactions between individuals involved in a point-of-sale transactions. Embodiments of the present invention include one or more processors generating a graphical user interface (GUI) (e.g., a thin client or a thick client) that one participant in the transaction can utilize to upload content. Meanwhile, the other individual involved in the transaction is provided with a signal of decodable indicia (e.g., a quick response (QR) code, a bar code, an RFID, etc.) which allows the user to access the content uploaded by the first individual. As will be described herein, these examples enable the users to extend this interaction and form social networking connections.

Embodiments of the present invention are inextricably linked to computing, provide a practical application, and offer significantly more than existing online secure-payment methods and connection individuals via social media. Embodiments of the present invention include, but are not limited to, computer-implemented methods, computer program products, and computer system that connect customers, in real-time, to service providers, such as tipped workers and performers, and enable these users to maintain connections after service has been provided (e.g., after a point-of sale transaction).

Embodiments of the present invention are inextricably linked to computing at least because embodiments of the present invention utilize a software program to generate a unique signal of decodable indicia. Signals of decodable indicia may include, but are not limited to bar codes, RFIDs, QR codes, etc. Throughout this disclosure, a QR code is provided as an example of a signal of decodable indicia, but this is just one example and is provided for illustrative purposes, only. Thus, as understood by one of skill in the art, examples herein which are illustrated with the use of unique QR codes are also useable with other types of signals of decodable indicia. Embodiments of the present invention are inextricably linked to computing as they generate and utilize unique QR codes and utilize an image capture device, such as a camera, to read the QR code, as well as one or more software programs to decode the QR code. Further, embodiments of the present invention are inextricably linked to computing at least because embodiments of the present invention utilize a device to run the software programs and visualize the resulting data in the QR code, e.g., a link to a website. In some embodiments, the device may be a smart phone with a camera, wherein the camera may be used to read the QR code and the smart phone may run the software program to decode the QR code. Embodiments of the present invention are also inextricably linked to computing because one aspect of the invention disclosed herein, a linkage between a unique identifier and a website or other application to provide content uploaded by a user to an individual utilizing the unique identifier (signal of decodable indicia) as a link, is wholly provided enabled and provide on a computing platform. From the generation of the QR code, the decoding of the QR code, the generation of the application, and the navigation to the application based on decoding the QR code, all aspects of this part of the disclosure rely upon a backbone of computing technologies.

Embodiments of the present invention have a practical application at least in that the system enables instantaneous, e.g., real-time and/or new real-time, and secured-tipping online at the location where the services are provided. Certain practical aspects of some embodiments of the present invention include providing a central location for service providers to create a user profile that expresses their goals and relates their experiences to customers. As explained herein, the user profile allows the service provider to share their stories and to brand connectors with their name and unique QR code. Additionally, embodiments of the present invention provide a practical application because the system enables a customer to connect with service providers and to maintain and/or grow that connection after service has been provided.

The practical applicability of the embodiments of the present invention is particularly observable in a situation where a service provider has performed appropriate services and the customer desires to provide a tip, but does not have cash on hand. Additionally, when the customer wishes to subsequently engage the service provider again, the system allows for a connection to be formed at the time of performance (e.g., at the point-of-sale) and to be maintained after provision of the service. Embodiments of the system immediately, e.g., in real-time (or near real-time), provide the customer with a way to securely tip the service provider and to follow the service provider. Further, the QR code may be placed on a wide range of connectors, e.g., products or advertising, at the location where service is provided and allows for instant access to information about the service provider and secure tipping for services performed.

The practical applicability of the embodiments of the present invention is particularly observable in a situation where the service provider is an independent performer and the service provided is a live performance. If the service provider places connectors, which are branded with its name and unique QR code, around the location of the performance, then a customer who enjoyed the performance but lacks cash on hand to provide a tip, or doesn't have time to leave one, may instead quickly scan the QR code and be instantly connected to the performer. Thus, the customer will see the performer's profile and may leave a tip at any time and from any place.

Embodiments of the present invention include various aspects that offer significantly more than existing online secure-payment methods and systems to connect individuals via social media. These aspects will be discussed in more detail herein. Unlike some existing online secure-payment methods and systems to connect individuals via social media, in some embodiments of the present invention, the online secure-payment method is directly coupled to the social media connection and is not a one-off event to render payment. Additionally, branded content and QR codes are placed on a product, e.g., business cards, badges, tip jars, etc. such that a customer has a direct link to the service provider's website for instant, secure digital tipping as well as forming a connection through the videos and stories on service provider's profile. This connection promotes interaction and may strengthen the feeling of loyalty.

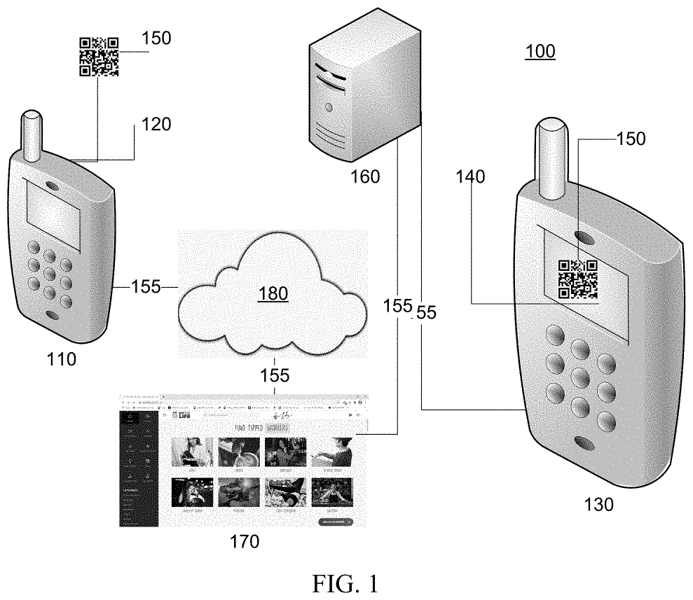

FIG. 1 is an example of a technical environment 100 into which aspects of some embodiments of the present invention can be implemented. The technical environment 100 includes a computing device 110 with a facility to capture and decode signals of decodable indicia 120. These facilities may include an image capture device, a scanner, and one or more programs that are executed by the processor(s) of the computing device 110, which decode the signals or images captured by the facility 120. The facility 120 can include hardware and/or software. The technical environment 100 also includes a second computing device 130, which executes a graphical user interface (GUI) 140, which enables a user of this device to request generation of a unique signal of decodable indicia 150. This user receives the unique signal of decodable indicia 150 and can place the unique signal of decodable indicia 150 on physical media at a point of sale (e.g., business cards, a placard, a tip jar, a badge, etc.). The unique signal of decodable indicia 150 is generated by one or more servers 160 (these servers can be part of either of the computing devices and/or separate). The servers 160 are communicatively coupled 155 to the second computing device 130. For ease of understanding, various types of network connections 155 in the technical environment 100 are labeled with the same signifier. In some embodiments of the present invention, the application (executed by the servers) that generates the unique signal of decodable indicia, also includes a store that offers, for purchase, items that include the signal of decodable indicia. When a user requests generated of the signal of decodable indicia, the user can also purchase items that include the signal of decodable indicia. These items can be understood as “connectors.” Upon receiving a request for the GUI 140 to generate a unique identifier, the one or more servers 160 also generate a URL (a given location or webpage on a website 170) and provide access to the user to this URL, for uploading content. Decoding the signal of decodable indicia navigates the device utilized to decode the signal to this URL. The first computing device 110 can access the URL over the Internet 180, including based on decoding the QR code and being redirected to the URL.

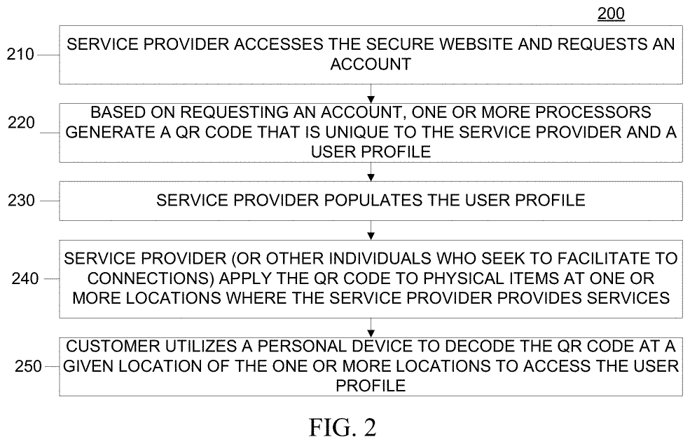

FIG. 2 is a workflow 200 that illustrates various aspects of some embodiments of the present invention. Specifically, this workflow 200 illustrates how aspects of some embodiments of the present invention can be utilized to create a connection between a customer and a service provider. This connection, which as explained herein, can move the communications of the customer and the service provider beyond a brief point-of-sale transactions, enables, for example digital tipping through product QR placement. As explained above, a QR code is utilized in the examples of one type of signal of decodable indicia that can be employed in various embodiments of the present invention.

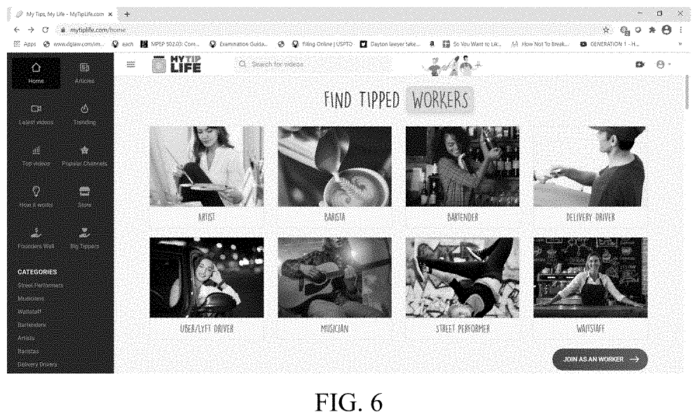

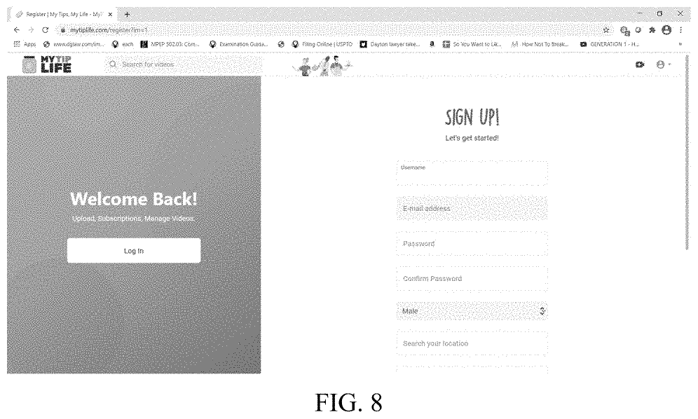

Returning to FIG. 2, FIG. 2 illustrates aspects in accordance with some embodiments of the present invention that are utilized to form a connection between a customer and a service provider. For ease of understanding, these aspects are compartmentalized into individual sections, but may contain additional sub-aspects in accordance with some embodiments of this invention. Referring to FIG. 2, a Service Provider accesses the secure website and requests an account (210). FIG. 6 is an example of an interface for this type of secure website and FIG. 8 is an example of a screen a Service Provider can navigate to in order to request an account. Based on requesting an account, one or more processors generate a QR code that is unique to the Service Provider and a user profile (at a unique URL that the QR code, when decoded, will direct a customer to) (220). The Service Provider populates the user profile (uploading content, including but not limited to, stories, goals, video, audio, text (230). In some embodiments of the present invention, the Service Provider individually requests the user profile and the QR code upon accessing the secure website (or application). In some embodiments, once the user has completed populating the profile (determined automatically or based on user input), the one or more processors automatically generate the QR code. The Service Provider (or other individuals who seek to facilitate to connections) apply the QR code to physical items at one or more locations where the Service Provider provides services (240). A Customer utilizes a personal device to decode the QR code at a given location of the one or more locations to access the user profile (250). Accessing the user profile, in some examples, enables the Customer to access securely tip the Service Provider and/or share in the experiences of the Service Provider through stories, videos, etc. on the Service Provider's profile page. The tipping mechanism can be hosted by the secure website and utilized by account holders (service providers), to enable customers to tip the service providers more easily.

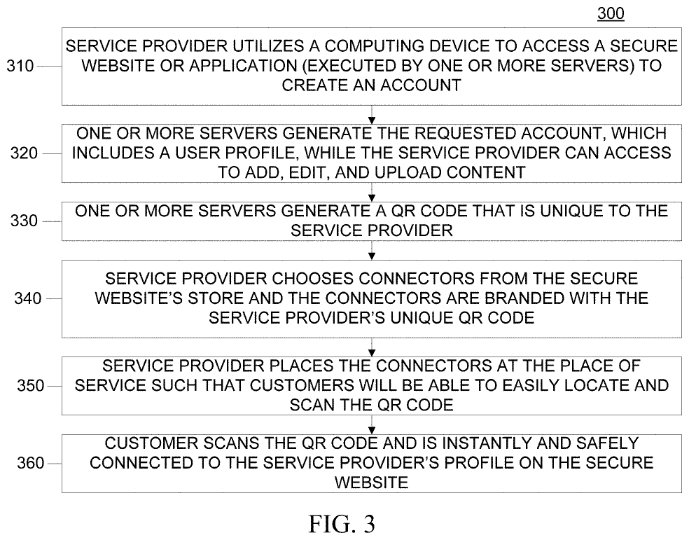

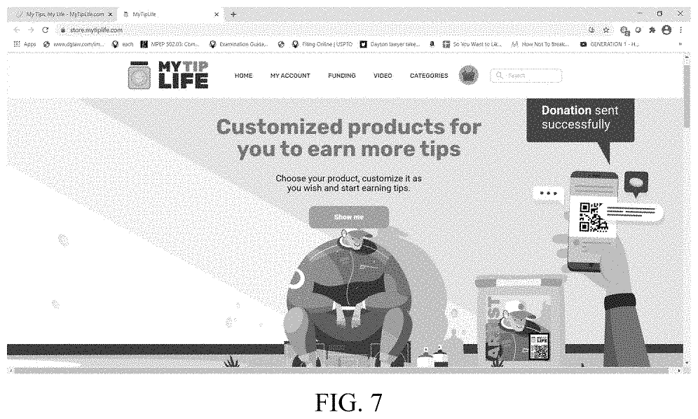

FIG. 3 is a workflow 300 that expands upon the connection that can be formed between a service provider and a customer. FIG. 3 also uses the example of how this connection can be utilized, among other things, for digital tipping. Referring to FIG. 3, various aspects of some embodiments of the present invention enable the formation of a connection (beyond a point-of-sale or point-of-service interaction) between a service provider and a customer. In some embodiments of the present invention, a Service Provider utilizes a computing device to access a secure website or application (executed by one or more servers) to create an account (310). The one or more servers generate the requested account, which includes a user profile, while the Service Provider can access to add, edit, and upload content (e.g., audio, video, text, stories, goals, electronic payment links) (320). The one or more servers generate a QR code that is unique to the Service Provider (330). The Service Provider chooses connectors from the secure website's store and the connectors are branded with the Service Provider's unique QR code (and optionally the Service Provider's name) (340). FIG. 7 is a screenshot of an example of a web store that the Service Provider can navigate to in order to purchase the connectors. The connectors may be various products, including but not limited to, business cards, tip jars, badges, etc. The Service Provider places the connectors at the place of service such that customers will be able to easily locate and scan the QR code (350). The customer scans the QR code and is instantly and safely connected to the Service Provider's profile on the secure website (360). The customer may choose to maintain the connection with the Service Provider by following their profile on the secure website or deepen the connection by watching videos or reading stories posted by the Service Provider.

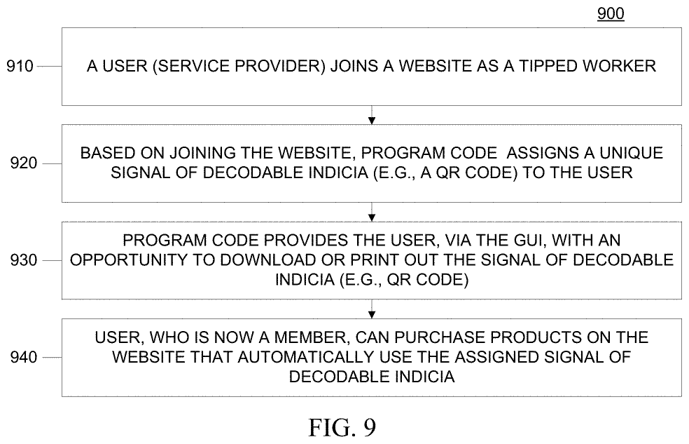

FIG. 9 is a workflow 900 from a point of view of a service provider as a user. As depicted in FIG. 9, a user joins a website as a tipped worker (910). FIG. 6 shows an example of a homepage for this website and a link to “join as worker” which the user may select in order to join (910). Meanwhile, FIG. 8 is a webpage which can be the destination of the “join as worker” link in FIG. 6. The webpage of FIG. 8 is a first signup page, provided as an illustrative example, which a user can utilize to join the website. The user would fill out the fields in this GUI to become a member. Based on joining the website, the program code (executing on one or more processors), assigns a signal of decodable indicia (e.g., a QR code) to the user (920). The program code provides the user, via the GUI, with an opportunity to download or print out the signal of decodable indicia (e.g., QR code) (930). The user, who is now a member, can purchase products on the website that automatically use the assigned signal of decodable indicia (940). An example of a page that the user can utilize to purchase these products (e.g., business cards, badges, tip jars, wearable items, placards, etc.) is depicted in FIG. 7. The listed products are provided as non-limiting examples in order to illustrate aspects of embodiments of the present invention and not to impose any limitations. As explained above, in some embodiments of the present invention, when a user scans the signal of decodable indicia, or otherwise utilized a computing device to capture and decode the signal of decodable indicia the computing device of the user (e.g., a phone), will navigate to the member-user's profile on eth website. The program code will display a “tip me” button on the profile page such that the customer can tip and member-user and/or otherwise interact with content uploaded by the member-user.

Embodiments of the present invention include a computer implemented method, a computer program product, and a computer system, where one or more programs executed on one or more processors obtain a signal of decodable indicia, wherein the signal of decodable indicia is obtained by the computing device from a physical medium at a point-of-sale. The one or more programs decode the signal of decodable indicia to access decoded data, where based on accessing the decoded data, the one or more processors automatically launch a web browser and navigate, based on the decodable data to a unique uniform resource locator, wherein the uniform resource locator is specified by the decoded data. The one or more programs initiate, based on input through a graphical user interface by a user of the computing device, at the unique uniform resource locator, an electronic transaction, where the electronic transaction is selected from the group consisting of: initiating an electronic commerce transaction, accessing content posted at the uniform resource locator, and transmitting an electronic communication.

In some embodiments of the present invention, the signal of decodable indicia is selected from the group consisting of: a quick response code, a bar code, and a radio frequency identification.

In some embodiments of the present invention, the signal of decodable indicia is unique.

In some embodiments of the present invention, obtaining the signal of decodable indicia comprises utilizing an image capture device on the computing device to capture an image of the signal of decodable indicia, wherein based on capturing the image, the one or more processors automatically decode the signal of decodable indicia.

In some embodiments of the present invention, the signal of decodable indicia is unique and generated by one or more servers.

In some embodiments of the present invention, the physical medium at the point-of-sale is selected from the group consisting of: a business card, a wearable item, and a tip jar.

In some embodiments of the present invention, the electronic transaction comprises accessing content posted at the uniform resource locator and the content is selected from the group consisting of: video, audio, and text.

In some embodiments of the present invention, the physical medium is placed at the point-of-sale by a user who posted the content at the uniform resource locator and transmitted, via a personal computing device, a command to the one or more servers to generate the signal of decodable indicia.

In some embodiments of the present invention, the one or more servers generating the signal of decodable indicia further comprises the one or more servers generating the uniform resource locator and a webpage at the uniform resource locator, wherein the webpage is utilized by the user to upload the content.

In some embodiments of the present invention, the computing device is selected from the group consisting of a wearable device, and implanted device, a handheld device, and a stationary device.

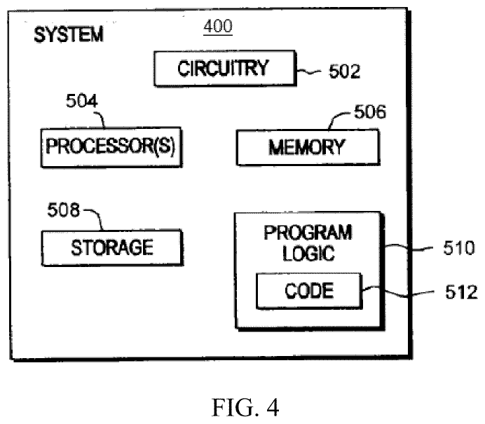

FIG. 4 illustrates a block diagram of a resource 400 in computer system (including the computing devices discussed above), such as, which is part of the technical architecture of certain embodiments of the technique. Returning to FIG. 4, the resource 400 may include a circuitry 502 that may in certain embodiments include a microprocessor 504. The computer system 400 may also include a memory 506 (e.g., a volatile memory device), and storage 508. The storage 508 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 508 may comprise an internal storage device, an attached storage device and/or a network accessible storage device. The system 400 may include a program logic 510 including code 512 that may be loaded into the memory 506 and executed by the microprocessor 504 or circuitry 502.

In certain embodiments, the program logic 510 including code 512 may be stored in the storage 508, or memory 506. In certain other embodiments, the program logic 510 may be implemented in the circuitry 502. Therefore, while FIG. 4 shows the program logic 510 separately from the other elements, the program logic 510 may be implemented in the memory 506 and/or the circuitry 502. The program logic 510 may include the program code discussed in this disclosure that facilitates the reconfiguration of elements of various computer networks, including those in various figures.

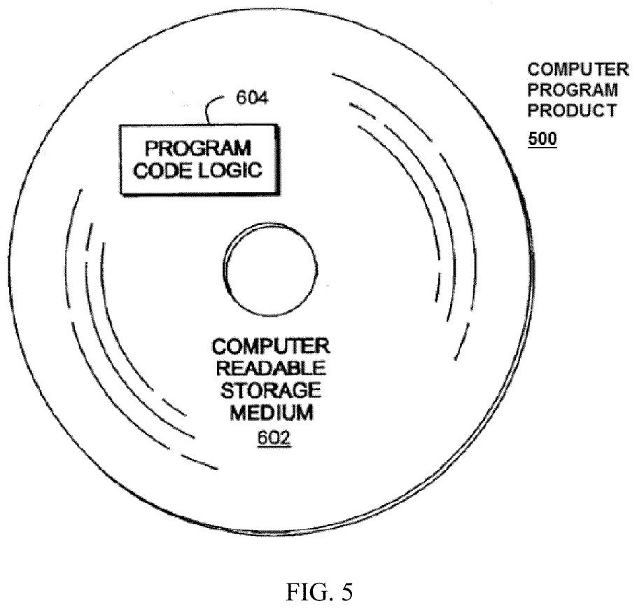

Using the processing resources of a resource 400 to execute software, computer-readable code or instructions, does not limit where this code can be stored. Referring to FIG. 5, in one example, a computer program product 500 includes, for instance, one or more non-transitory computer readable storage media 602 to store computer readable program code means or logic 604 thereon to provide and facilitate one or more aspects of the technique.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the technique may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the technique may be written in any combination of one or more programming languages, including an object oriented programming language, such as Java, Smalltalk, C++ or the like, and conventional procedural programming languages, such as the “C” programming language, PHP, ASP, assembler or similar programming languages, as well as functional programming languages and languages for technical computing (e.g., Python, Matlab). The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Furthermore, more than one computer can be used for implementing the program code, including, but not limited to, one or more resources in a cloud computing environment.

Aspects of the technique are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions, also referred to as software and/or program code, may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technique. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the technique may be provided, offered, deployed, managed, serviced, etc. by a service provider who offers management of customer environments. For instance, the service provider can create, maintain, support, etc. computer code and/or a computer infrastructure that performs one or more aspects of the technique for one or more customers. In return, the service provider may receive payment from the customer under a subscription and/or fee agreement, as examples. Additionally or alternatively, the service provider may receive payment from the sale of advertising content to one or more third parties.

In one aspect of the technique, an application may be deployed for performing one or more aspects of the technique. As one example, the deploying of an application comprises providing computer infrastructure operable to perform one or more aspects of the technique.

As a further aspect of the technique, a computing infrastructure may be deployed comprising integrating computer readable code into a computing system, in which the code in combination with the computing system is capable of performing one or more aspects of the technique.

As yet a further aspect of the technique, a process for integrating computing infrastructure comprising integrating computer readable code into a computer system may be provided. The computer system comprises a computer readable medium, in which the computer medium comprises one or more aspects of the technique. The code in combination with the computer system is capable of performing one or more aspects of the technique.

Further, other types of computing environments can benefit from one or more aspects of the technique. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the technique, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or steps plus function elements in the descriptions below, if any, are intended to include any structure, material, or act for performing the function in combination with other elements as specifically noted. The description of the technique has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular uses contemplated.

1. A computer-implemented method, the method comprising:
obtaining, by one or more processors of a computing device, a signal of decodable indicia, wherein the signal of decodable indicia is obtained by the computing device from a physical medium at a point-of-sale;
decoding, by the one or more processors, the signal of decodable indicia to access decoded data, wherein based on accessing the decoded data, the one or more processors automatically launch a web browser and navigate, based on the decodable data to a unique uniform resource locator, wherein the uniform resource locator is specified by the decoded data; and
initiating, by the one or more processors, based on input through a graphical user interface by a user of the computing device, at the unique uniform resource locator, an electronic transaction, wherein the electronic transaction is selected from the group consisting of: initiating an electronic commerce transaction, accessing content posted at the uniform resource locator, and transmitting an electronic communication.

2. The computer-implemented method of claim 1, wherein the signal of decodable indicia is selected from the group consisting of: a quick response code, a bar code, and a radio frequency identification.

3. The computer-implemented method of claim 1, wherein the signal of decodable indicia is unique.

4. The computer-implemented method of claim 1, wherein obtaining the signal of decodable indicia comprises utilizing an image capture device on the computing device to capture an image of the signal of decodable indicia, wherein based on capturing the image, the one or more processors automatically decode the signal of decodable indicia.

5. The computer-implemented method of claim 1, wherein the signal of decodable indicia is unique and generated by one or more servers.

6. The computer-implemented method of claim 1, wherein the physical medium at the point-of-sale is selected from the group consisting of: a business card, a wearable item, and a tip jar.

7. The computer-implemented method of claim 5, wherein the electronic transaction comprises accessing content posted at the uniform resource locator and the content is selected from the group consisting of: video, audio, and text.

8. The computer-implemented method of claim 7, wherein the physical medium is placed at the point-of-sale by a user who posted the content at the uniform resource locator and transmitted, via a personal computing device, a command to the one or more servers to generate the signal of decodable indicia.

9. The computer-implemented method of claim 8, wherein the one or more servers generating the signal of decodable indicia further comprises the one or more servers generating the uniform resource locator and a webpage at the uniform resource locator, wherein the webpage is utilized by the user to upload the content.

10. The computer-implemented method of claim 1, wherein the computing device is selected from the group consisting of a wearable device, and implanted device, a handheld device, and a stationary device.

11. A computer program product comprising:
a computer readable storage medium readable by one or more processors and storing instructions for execution by the one or more processors for performing a method comprising:
obtaining, by the one or more processors, a signal of decodable indicia, wherein the signal of decodable indicia is obtained by the one or more processors from a physical medium at a point-of-sale;
decoding, by the one or more processors, the signal of decodable indicia to access decoded data, wherein based on accessing the decoded data, the one or more processors automatically launch a web browser and navigate, based on the decodable data to a unique uniform resource locator, wherein the uniform resource locator is specified by the decoded data; and
initiating, by the one or more processors, based on input through a graphical user interface by a user of the computing device, at the unique uniform resource locator, an electronic transaction, wherein the electronic transaction is selected from the group consisting of: initiating an electronic commerce transaction, accessing content posted at the uniform resource locator, and transmitting an electronic communication.

12. The computer program product of claim 11, wherein the signal of decodable indicia is selected from the group consisting of: a quick response code, a bar code, and a radio frequency identification.

13. The computer program product of claim 11, wherein the signal of decodable indicia is unique.

14. The computer program product of claim 11, wherein obtaining the signal of decodable indicia comprises utilizing an image capture device on the computing device to capture an image of the signal of decodable indicia, wherein based on capturing the image, the one or more processors automatically decode the signal of decodable indicia.

15. The computer program product of claim 11, wherein the signal of decodable indicia is unique and generated by one or more servers.

16. The computer program product of claim 11, wherein the physical medium at the point-of-sale is selected from the group consisting of: a business card, a wearable item, and a tip jar.

17. The computer program product of claim 15, wherein the electronic transaction comprises accessing content posted at the uniform resource locator and the content is selected from the group consisting of: video, audio, and text.

18. The computer program product of claim 17, wherein the physical medium is placed at the point-of-sale by a user who posted the content at the uniform resource locator and transmitted, via a personal computing device, a command to the one or more servers to generate the signal of decodable indicia.

19. The computer program product of claim 18, wherein the one or more servers generating the signal of decodable indicia further comprises the one or more servers generating the uniform resource locator and a webpage at the uniform resource locator, wherein the webpage is utilized by the user to upload the content.

20. A system comprising:
a memory;
one or more processors in communication with the memory;
program instructions executable by the one or more processors via the memory to perform a method, the method comprising:
obtaining, by the one or more processors, a signal of decodable indicia, wherein the signal of decodable indicia is obtained by the one or more processors from a physical medium at a point-of-sale;
decoding, by the one or more processors, the signal of decodable indicia to access decoded data, wherein based on accessing the decoded data, the one or more processors automatically launch a web browser and navigate, based on the decodable data to a unique uniform resource locator, wherein the uniform resource locator is specified by the decoded data; and
initiating, by the one or more processors, based on input through a graphical user interface by a user of the computing device, at the unique uniform resource locator, an electronic transaction, wherein the electronic transaction is selected from the group consisting of: initiating an electronic commerce transaction, accessing content posted at the uniform resource locator, and transmitting an electronic communication.
